(19) United States
(12) Patent Application Publication
(10) Pub. No.: US 2008/0110301 A1
(43) Pub. Date: May 15, 2008

(54) WIRE CONNECTOR DRIVER

(75) Inventors: Bruce D. DeRuntz, Carbondale, IL (US); Christopher R. DeRuntz, Granite City, IL (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: BOARD OF TRUSTEES OF SOUTHERN ILLINOIS UNIVERSITY, Carbondale, IL (US)

(21) Appl. No.: 12/013,200

(22) Filed: Jan. 11, 2008

Related U.S. Application Data
(63) Continuation of application No. 11/588,755, filed on Oct. 27, 2006, now abandoned.

(51) Int. Cl. B25B 13/48

(52) U.S. Cl. 81/176.1

(57) ABSTRACT

A wire connector driver for the installation and removal of wire connector devices, comprising a housing, with a first internal cavity, for receiving wire nut connectors, the cavity having a series of curved protrusions extending radially inward and extending in a substantially perpendicular direction from the first surface and providing a variety of points where contact with wire nut connectors is established to transfer rotational and directional force, and a series of channels between the curved protrusions which accommodates the various shapes of wire connector devices of different designs. The wire connector driver also has an optional second internal cavity, for receiving hexagon-shaped drivers attached to screw guns or drills. A third surface, between the first and second surfaces, can have ridges or grooves, and can have wings extending outward, so that the wire connector driver can be used manually.

### CROSS-REFERENCE TO RELATED APPLICATION

This patent application is a continuation application that claims priority from U.S. non-provisional patent application Ser. No. 11/588,755 filed on Oct. 27, 2006 and is herein incorporated by reference in its entirety.

### FIELD

This document relates generally to a tool for use in wiring electrical systems, and more particularly to a tool for the installation and removal of wire connectors to a wire or plurality of wires.

### BACKGROUND

Solderless wire connectors, commonly known by the term wire nuts have been known and available for many years. Wire connectors are generally installed by hand twisting, which may cause finger and hand fatigue and pain when many wire connectors are required to be installed or removed, such as when practitioners are required to install large quantities of wire nuts when wiring a home or commercial structure. There is known in the art sockets and tools which can be used to assist in installing wire nut connectors, as well as hand ratchet devices, driven sockets attached to cordless battery-powered screw guns, or electrically-powered drills may also be utilized to accomplish installation. These sockets and tools tend to be designed for use with only one or two types of a particular manufacturer's wire nut, even though there are many types of wire nut connectors available on the market.

It is known in the prior art that hand-held wrenches may be used with helicalspring wire nut connectors. These designs include wire connector-specific gripping cavities to match specific versions of the various sizes and designs of the wire nut connectors, thereby making their applicability limited to a limited types of wire nut connectors. These hand-held wrenches are also designed for manual operation only.

There are several devices known as wire connector drivers for use specifically with powered drills or screw guns. These wire connector drivers have permanently-attached shafts that require a tool change in the chuck of the drill or screw gun in order to be used. In general practice, electricians use a screw gun most often with a hexagon-shaped driver, such as a screwdriver bit having a Phillips-head, slotted-head, or square-drive head screws, for connecting electrical devices and fixtures within the structures being wired. However, it is disadvantageous to require the removal of this hexagon-shaped driver in order to use the wire connector driver, or to require an additional screw gun dedicated solely to a particular wire connector driver. Most of these prior art drivers share two disadvantages: they cannot be used manually, and they generally only work with a particular wire nut design of a single manufacturer.

Prior art wire connector drivers may include multiple bores for use with different sized wire connectors in one driver. These wire connector drivers utilize internal bore surfaces with contours of ribs and channels which are precisely complementary and mesh closely with the exterior surfaces of a wire connector, sometimes including two separate slots or grooves to accommodate the wings of some wire nut designs, and many smaller grooves or ribs to accommodate the ridges or knurling of one other wire nut design. In these wire connector drivers the winged wire nuts can only be inserted when aligned with one of the two rotational positions that accommodate the winged extensions. This is a disadvantage since it more difficult to align a winged wire nut in the wire connector driver. Further, the internal bores of these wire connector drivers utilize complex surfaces, which raise manufacturing difficulty and cost. Still further, where multiple bores are described, the most commonly used wire connector sizes reside deep in the bore, making their use difficult because the wires must be inserted far into the cavity, thereby making accurate alignment difficult.

Thus, there is a need in the art for a wire connector driver which overcomes the disadvantages discussed above.

### SUMMARY

In an embodiment, a wire connector driver for the installation and removal of a wire connector may include a housing defining a first and a second surfaces with the first and second surfaces both being located on an external boundary of the housing. A first internal cavity may be defined by the housing and open to the first surface for receiving the wire connector, while the first internal cavity has a longitudinal axis in common with a rotational axis of the housing, and the first internal cavity has a first internal cavity surface with a series of curved protrusions extending radially inward from the first internal cavity surface. A series of curved protrusions each extend in a substantially perpendicular direction from the first surface along the first internal cavity surface and provide a variety of points where contact with the wire connector is established to transfer rotational and directional force applied to the housing. The first internal cavity may include a plurality of channels defined between the series of curved protrusion with the plurality of channels having a configuration adapted to accommodate different sizes of the wire connector.

In another embodiment, a wire connector driver for the installation and removal of a wire connector may include a housing defining a first and a second surfaces with the first and second surfaces both located on an external boundary of the housing and a first internal cavity in the housing and open to the first surface for receiving the wire connector. The first internal cavity has a longitudinal axis in common with a rotational axis of the housing, and the first internal cavity has a first internal cavity surface with a series of curved protrusions extending radially inward from the first internal cavity surface. The series of curved protrusions each extend in a substantially perpendicular direction from the first surface along the first internal cavity surface and provide a variety of points where contact with the wire connector is established to transfer rotational and directional force. The first internal cavity may include a plurality of channels between the series of curved protrusions with the plurality of channels having a configuration adapted to accommodate different sizes of wire connector device. A second internal cavity in the body and open to the second surface for receiving a rotational driving tool with the second internal cavity having a longitudinal and rotational axis in common with the longitudinal and rotational axis of the first internal cavity, wherein the first internal cavity and the second internal cavity are in communication with each other. A third surface is located on an external boundary of the housing which is further located adjoining and in between the first and second surfaces, wherein the third surface is tapered from a minimum diameter about the rotational axis of the housing at the second surface to a maximum diameter about the rotational axis at or near the first surface. The third surface may further include ridges formed on the third surface.

Implementation of the above embodiments may include one or more of the following features:

The first internal cavity is tapered from its widest diameter at the first surface.

The series of curved protrusions consists of ten uniform protrusions spaced equidistant around the first internal cavity surface.

The third surface being located on an external boundary of the housing and further located adjoining and in between the first and second surfaces.

The third surface is tapered from a minimum diameter about the rotational axis of the housing at the second surface, to a maximum diameter about the rotational axis at or near the first surface.

The wire connector driver further includes ridges formed on the third surface of the housing.

The wire connector driver further includes grooves formed in the third surface of the housing.

The wire connector driver further includes at least two wings extending radially outward from the third surface of the housing.

The wire connector driver further includes a second internal cavity being defined by the housing and open to the second surface for receiving a rotational driving tool, the second internal cavity having a longitudinal and rotational axis in common with the longitudinal and rotational axis of the first internal cavity.

The first internal cavity is in communication with the second internal cavity.

The communication between the first internal cavity and the second internal cavity is formed to allow a ground wire to extend from the wire connector into and through the second internal cavity.

The second internal cavity has a hexagonal cross-section.

The second internal cavity is tapered from its widest diameter about the rotational axis at the second surface.

The surface of the second internal cavity further comprises a moveable protrusion adapted to engage a hexagon-shaped driver.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a side view of a preferred embodiment of the wire connector driver;

FIG. 2 is a bottom view of the wire connector driver;

FIG. 3 is a top view of the wire connector driver;

FIG. 4 is a trimetric view of the wire connector driver;

FIG. 5 is a front view of the wire connector driver; and

FIG. 6 is a cross-sectional view of the wire connector driver, along line 6-6 in FIG. 5.

Corresponding reference characters indicate corresponding elements among the view of the drawings. The headings used in the figures should not be interpreted to limit the scope of the claims.

### DETAILED DESCRIPTION

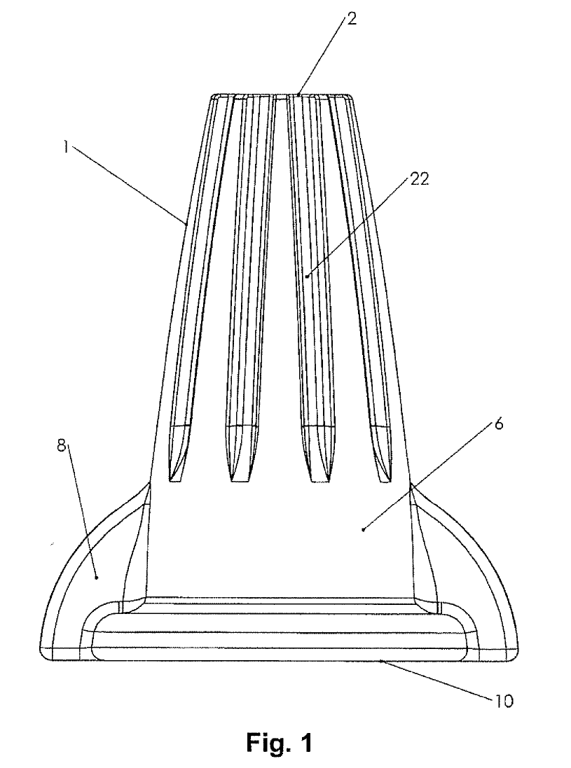

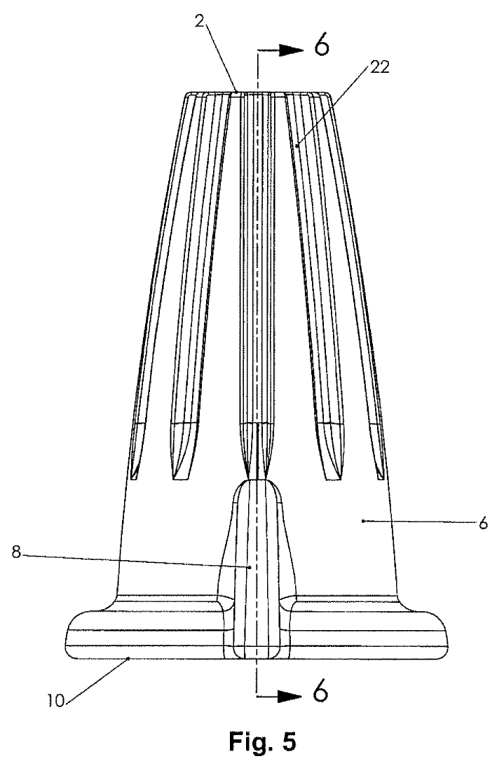

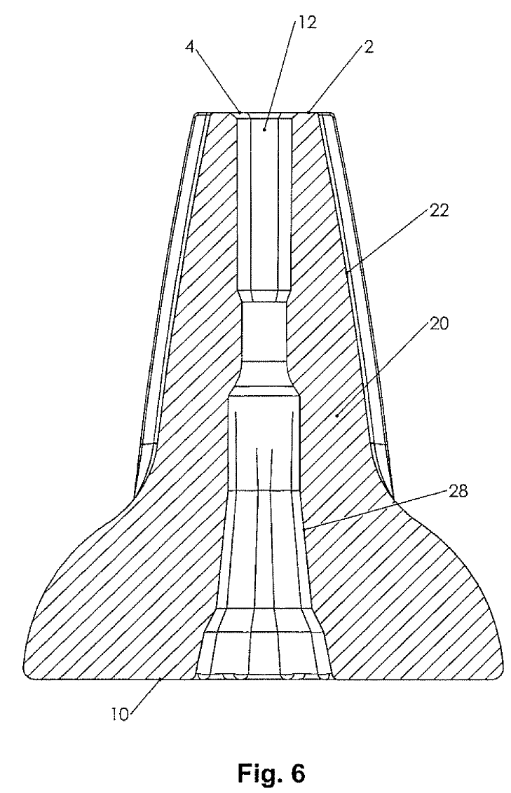

An embodiment of the wire connector driver is shown generally indicated as 1 in FIGS. 1 through 6. Referring to FIG. 1, wire connector driver 1 defines a first surface 10, a second surface 2 and third surface 6. In one embodiment, the second surface 2 and third surface 6 may be combined into a single, curved surface, or in another embodiment the first surface 10 and third surface 6 may be combined into a single, curved surface. Extending radially outward from the third surface 6 is a wing 8, that provides a surface upon which the fingers and thumbs of the user's hands may apply pressure to achieve maximum torque during operation of the wire connector driver 1. In one embodiment the wire connector driver 1 may include two wings 8, diametrically opposed to each other, however other embodiments may include a fewer or greater number of wings 8 having various shapes located either in regular or irregular locations around the outer radius of the wire connector driver 1. In another embodiment, the wire connector driver 1 may have no wings 8 at all. A feature of the wire connector driver 1 is the gradual taper or curve of the third surface 6 such that the cross-sectional diameter of housing 20, shown in FIG. 6, measured at third surface 6 is at a minimum near second surface 2 and gradually increases along third surface 6 to a maximum at or near first surface 10. This gradual taper or curve permits a person gripping the wire connector driver 1 to apply both rotational force as well and linear force along the rotational axis of the driver 1. In an alternate embodiment, the wire connector driver 1 may include optional slots, grooves or indentations formed as part of the third surface 6, shown as 22, in order to increase the ability of the user to grip the driver 1 with the hands.

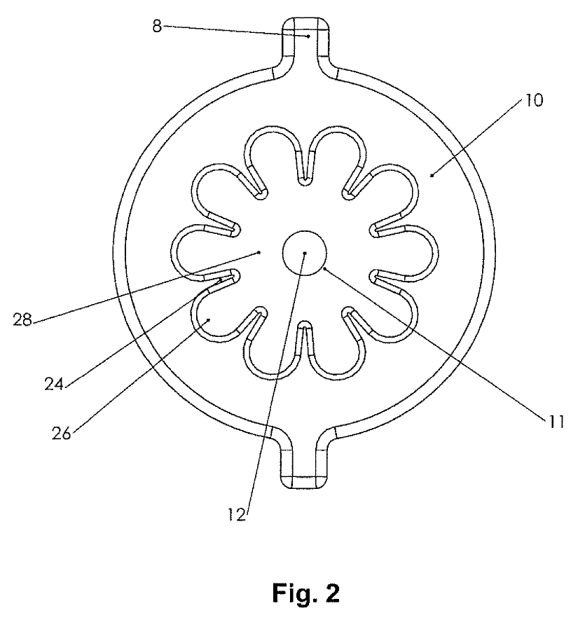

Referring to FIG. 2, wire connector driver 1 includes a housing 20 defining a first internal cavity 11 which accepts wire connectors, known in the art for installation or removal from the ends of electrical wires (not shown). One of the features of the wire connector driver 1 are the channels 26 which are defined between the curved protrusions 24 that extend radially inward from a surface 28 of the first internal cavity 11. The channels 26 are formed to accommodate a wide variety of commonly available wire connectors, such as ribbed and grooved types, winged types including those with large or small wings, radially projecting wings, or non-radially projecting, parallel, and offset wings, which are all well known in the art.

In one embodiment, the wire connector driver 1 is designed so that ten identical channels 26 are formed as part of the first internal cavity 11. Identically-shaped channels 26 keep fabrication costs low as well as enable the wire connectors to be accommodated in ten different rotational positions around the rotational axis of the wire connector driver 1, such that there is no single channel 26 into which a wire nut will not fit. It is contemplated that the number of channels 26 may vary in other embodiments of the wire connector driver 1 and that channels 26 of varying shapes within the same wire connector driver 1 may be utilized in these other embodiments. In one aspect, the wire connector driver 1 utilizes channels 26 designed not to match the exterior shape of any one available wire connector and are adapted to provide different contours to match the exterior shape of different types of wire connectors. Instead the channels 26 as noted above are adapted to accommodate different shaped wire connectors using a single, repeated channel design by providing contact points at different locations along the curved protrusions 24 in order to transfer rotational force from the housing 20 to different contact points on each of the different bodies of the wire connectors used with the wire connector driver 1.

The wire connector driver 1 further includes a second internal cavity 12 adjacent the second surface 2 at one end of the housing 20 opposite from the first internal cavity 11. In one embodiment, first internal cavity 11 may be in communication with the second internal cavity 12 to permit a wire (not shown), protruding through the top of a grounding-type wire connector, to extend through the wire connector driver 1 as well as into and through the second internal cavity 12. It is contemplated that the wire connector driver 1 may be fabricated in other ways, such as not having the first and second internal cavities 11 and 12 in communication with each other, or having the first internal cavity 11 communicate with an additional passageway (not shown) to the third surface 6, or first surface 2.

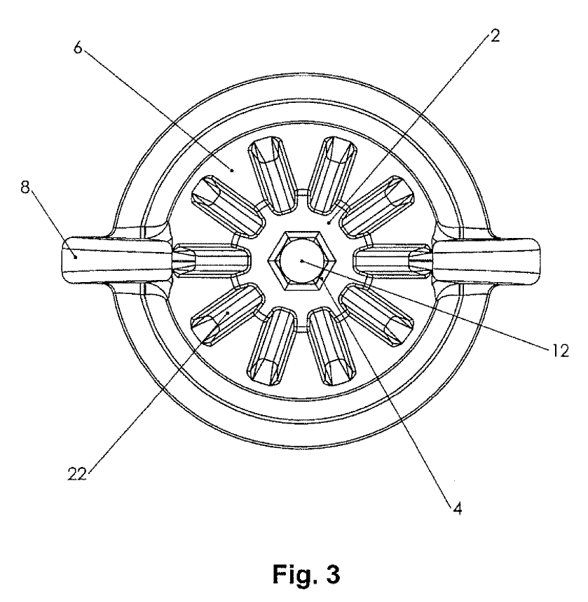

The second internal cavity 12, and the surface of the second internal cavity 4 are shown in FIG. 3, which illustrates their location relative to the slots, grooves or indentations designated as 22, the third surface 6, and the second surface 2. In one embodiment, the second internal cavity 12 is adapted to snugly accommodate a hexagon-shaped driver, such as a screwdriver bit, used with a drill or battery-operated screw gun, or similar tool. A key advantage of the second internal cavity 12 designed to accommodate such an existing tool is that hexagon-shaped drivers are the preferred insert for screw guns (not shown) when doing electrical work. Accommodating the hexagon-shaped driver to be inserted into the wire connector driver 1 so as to power the wire connector driver 1 using the torque of the screw gun, permits a user to quickly and easily use the wire connector driver 1 without having to change the tool that is presently in the chuck of the screw gun or drill. Further, the second internal cavity 12 is a feature that is relatively inexpensive to fabricate as compared to a feature such as a drive shaft that would be permanently mounted into the housing 20 of the wire connector driver 1.

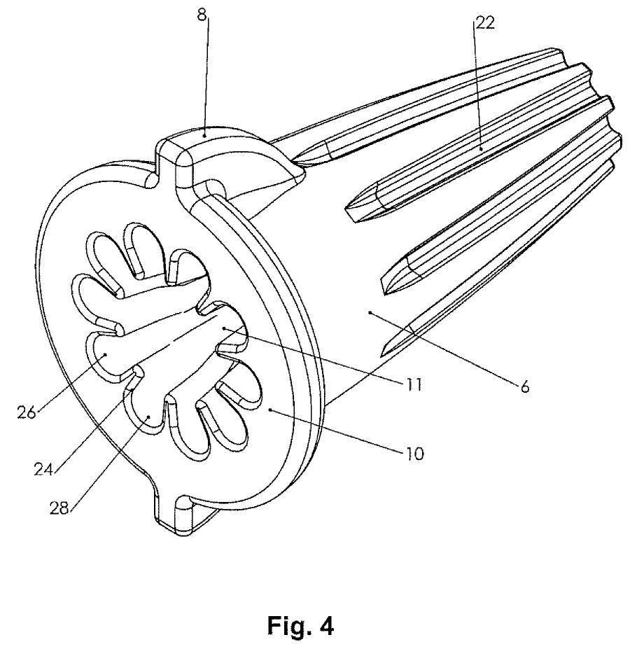

FIG. 4 illustrates the first internal cavity 11 in relationship with first surface 10, wing 8, and third surface 6. In practice, several different size ranges of wire connectors are contemplated for use with different sized and numbers of wires. The practice in the industry is to color-code the wire connectors depending upon the size range. The most common sizes are represented by yellow and red wire connectors, with additional sizes available in orange, grey, and blue. Special-purpose wire connectors for grounding applications are green, and are in the size family of red wire connectors. In one embodiment, a version of the wire connector driver 1 is fabricated for two wire connector sizes, such as for red, green, and yellow wire connectors, which are relatively close in size to each other as compared to the connector sizes. It is contemplated that the wire connector driver 1 may be fabricated to accommodate one or a plurality of wire connector sizes. A wire connector driver 1 which can accommodate more than one size family of wire connectors reduces the number of tools necessary, and reduces tool changing when wire connector size changes. However, skilled electricians use primarily the red and yellow sizes for wiring projects. One advantage of the single-size or dual-size wire connector driver 1 is that the first internal cavity 11 can be fabricated so that when a wire connector is introduced to the wire connector driver 1, it aligns near the first surface 10 instead of locating deep in the cavity out of sight of the user. If the wire connector resides deep into the cavity, aligning the wire connector exactly with each of the wires to be connected can be challenging task. This is the case if a wire connector driver 1 that can accommodate four or five sizes is used with a very small wire nut.

FIG. 6 shows the surface of the third internal cavity 28, which is the boundary of the first internal cavity 11, identified in FIGS. 2 and 4, in relation to the second internal cavity 12 within the housing 20 of the wire connector driver 1. In the one embodiment, the first internal cavity 11 is in communication with the second internal cavity 12. The housing 20 may be fabricated from an injection-molded thermosetting or thermoplastic material. It is contemplated that other materials that provide stability, durability, strength and ease of manufacture could be utilized to manufacture the wire connector driver 1.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

It is claimed:

1. A wire connector driver for the installation and removal of a wire connector, comprising:
a housing defining a first and a second surfaces, the first and second surfaces both located on an external boundary of said housing;
a first internal cavity defined by said housing and open to said first surface for receiving the wire connector, said first internal cavity having a longitudinal axis in common with a rotational axis of the housing, and said first internal cavity having a first internal cavity surface with a series of curved protrusions extending radially inward from said first internal cavity surface and said series of curved protrusions each extending in a substantially perpendicular direction from said first surface along said first internal cavity surface and providing a variety of points where contact with the wire connector is established to transfer rotational and directional force applied to said housing, and said first internal cavity including a plurality of channels defined between said series of curved protrusions, said plurality of channels having a configuration adapted to accommodate different sizes of the wire connector.

2. The wire connector driver of claim 1 in which said first internal cavity is tapered from its widest diameter at said first surface.

3. The wire connector driver of claim 1 in which said series of curved protrusions consists of ten uniform protrusions spaced equidistant around said first internal cavity surface.

4. The wire connector driver of claim 1 further comprising a third surface, said third surface being located on an external boundary of said housing and further located adjoining and in between said first and second surfaces.

5. The wire connector driver of claim 4 wherein said third surface is tapered from a minimum diameter about said rotational axis of the housing at said second surface, to a maximum diameter about said rotational axis at or near said first surface.

6. The wire connector driver of claim 4 further comprising ridges formed on said third surface of said housing.

7. The wire connector driver of claim 4 further comprising grooves formed in said third surface of said housing.

8. The wire connector driver of claim 4 further comprising at least two wings extending radially outward from said third surface of said housing.

9. The wire connector driver of claim 1 further comprising a second internal cavity being defined by said housing and open to said second surface for receiving a rotational driving tool, said second internal cavity having a longitudinal and rotational axis in common with said longitudinal and rotational axis of said first internal cavity.

10. The wire connector driver of claim 9 wherein said first internal cavity is in communication with said second internal cavity.

11. The wire connector driver of claim 9 wherein said communication between said first internal cavity and said second internal cavity is formed to allow a ground wire to extend from the wire connector into and through said second internal cavity.

12. The wire connector driver of claim 9 wherein said second internal cavity has a hexagonal cross-section.

13. The wire connector driver of claim 9 wherein said second internal cavity is tapered from its widest diameter about said rotational axis at said second surface.

14. The wire connector driver of claim 9 wherein said surface of said second internal cavity further comprises a moveable protrusion adapted to engage a hexagon-shaped driver.

15. A wire connector driver for the installation and removal of a wire connectors, comprising:
a housing defining a first and a second surfaces, said first and second surfaces both located on an external boundary of said housing;
a first internal cavity in said housing and open to said first surface for receiving the wire connector, said first internal cavity having a longitudinal axis in common with a rotational axis of the housing, and said first internal cavity having a first internal cavity surface with a series of curved protrusions extending radially inward from said first internal cavity surface and said series of curved protrusions each extending in a substantially perpendicular direction from said first surface along said first internal cavity surface and providing a variety of points where contact with the wire connector is established to transfer rotational and directional force, and said first internal cavity including a plurality of channels between said series of curved protrusions, said plurality of channels having a configuration adapted to accommodate different sizes of wire connector device;
a second internal cavity in said body and open to said second surface for receiving a rotational driving tool, said second internal cavity having a longitudinal and rotational axis in common with said longitudinal and rotational axis of said first internal cavity, wherein said first internal cavity and said second internal cavity are in communication with each other;
a third surface, located on an external boundary of said housing, further located adjoining and in between said first and second surfaces, wherein said third surface is tapered from a minimum diameter about said rotational axis of the housing at said second surface, to a maximum diameter about said rotational axis at or near said first surface, and said third surface further comprising ridges formed on said third surface.
